(19) United States
(12) Patent Application Publication
(10) Pub. No.: US 2024/0202307 A1
(43) Pub. Date: Jun. 20, 2024

(54) SYSTEMS AND METHODS FOR VERIFYING A SOFTWARE PRODUCT USING A SOFTWARE-SUPPLY-CHAIN-PROVENANCE VERIFICATION SERVICE

(71) Applicant: Palantir Technologies Inc., Denver, CO (US)

(72) Inventors: Casey Silver, Seattle, WA (US); Dan Fox, Washington, DC (US); Kasper Nielsen, Frederiksberg (DE); Nicholas Miyake, Emerald Hills, CA (US)

(21) Appl. No.: 18/523,291

(22) Filed: Nov. 29, 2023

Related U.S. Application Data
(60) Provisional application No. 63/433,523, filed on Dec. 19, 2022.

(51) Int. Cl. G06F 21/44; G06F 21/57

(52) U.S. Cl. CPC G06F 21/44; G06F 21/572; G06F 2221/033

(57) ABSTRACT

In some examples, systems and methods for verifying a software product using a software-supply-chain-provenance verification service are provided. For example, a method includes: receiving, at the software-supply-chain-provenance verification service from a deployment management system, an indication of a first software product for verification, retrieving one or more artifacts associated with the first software product for verification, performing provenance verification to the one or more artifacts to generate one or more results, and sending the one or more results of the provenance verification and the indication of the first software product to the deployment management system. The deployment management system is configured to: determine whether the first software product satisfies a security policy of a release channel based at least in part on the one or more results of the provenance verification, and allowing for the first software product to be installed through the release channel.

### CROSS REFERENCE TO RELATED APPLICATIONS

This application claims priority to U.S. Provisional Application Nos. 63/433,523, entitled “SYSTEMS AND METHODS FOR VERIFYING A SOFTWARE PRODUCT USING A SOFTWARE-SUPPLY-CHAIN-PROVENANCE VERIFICATION SERVICE,” and filed on Dec. 19, 2022, which is incorporated by reference herein for all purposes in its entirety.

### TECHNICAL FIELD

Certain embodiments of the present disclosure relate to verifying software products. More particularly, some embodiments of the present disclosure relate to verifying software products using a software-supply-chain-provenance verification service, such as based on based on an indication of the software products received from a deployment management system.

### BACKGROUND

A software-supply-chain is composed of multiple steps that transform or verify a state of a project in order to drive it to a final software product. Security of a software-supply-chain can contribute to an overall security of a software product. For example, an attacker who is able to control a step in a supply chain may be able to alter the final software product for malicious intents.

Hence, it is desirable to improve techniques for software-supply-chain-provenance verification services.

### SUMMARY

Certain embodiments of the present disclosure relate to verifying software products. More particularly, some embodiments of the present disclosure relate to verifying software products using a software-supply-chain-provenance verification service, such as based on based on an indication of the software products received from a deployment management system.

At least some aspects of the present disclosure are directed to a method for verifying a software product using a software-supply-chain-provenance verification service. The method includes receiving, at the software-supply-chain-provenance verification service from a deployment management system, an indication of a first software product for verification. The method further includes retrieving one or more artifacts associated with the first software product for verification, performing provenance verification to the one or more artifacts to generate one or more results, and sending the one or more results of the provenance verification and the indication of the first software product to the deployment management system. The deployment management system is configured to determine whether the first software product satisfies a security policy of a release channel based at least in part on the one or more results of the provenance verification, and in response to the first software product being determined to satisfy the security policy, allow for the first software product to be installed through the release channel.

At least some aspects of the present disclosure are directed to a method for verifying a software product using a software-supply-chain-provenance verification service. The method includes sending, from a deployment management system to a software-supply-chain-provenance verification service, an indication of a first software product, receiving, from the software-supply-chain-provenance verification service, one or more results of a provenance verification of one or more artifacts associated with the first software product, storing the results of the provenance verification as a property of the indication of the first software product, determining whether the first software product satisfies a security policy of a release channel based at least in part on the one or more results of the provenance verification, and in response to the first software product being determined to satisfy the security policy, allowing for the first software product to be installed through the release channel.

At least some aspects of the present disclosure are directed to a system for verifying a software product using a software-supply-chain provenance verification service. The system includes a processor, and memory storing instructions that, when executed by the processor, cause the system to perform a set of operations. The set of operations include sending, from a deployment management system to a software-supply-chain-provenance verification service, an indication of a first software product, receiving, from the software-supply-chain-provenance verification service, one or more results of a provenance verification of one or more artifacts associated with the first software product, storing the results of the provenance verification as a property of the indication of the first software product, determining whether the first software product satisfies a security policy of a release channel based at least in part on the one or more results of the provenance verification, and in response to the first software product being determined to satisfy the security policy, allowing for the first software product to be installed through the release channel.

Depending upon embodiment, one or more benefits may be achieved. These benefits and various additional objects, features and advantages of the present disclosure can be fully appreciated with reference to the detailed description and accompanying drawings that follow.

### BRIEF DESCRIPTION OF THE DRAWINGS

FIG. 1 illustrates a simplified diagram showing a method for verifying a software product using a software-supply-chain-provenance verification service, according to certain embodiments of the present disclosure.

FIG. 2 illustrates a simplified diagram showing a method for verifying a software product using a software-supply-chain-provenance verification service, according to certain embodiments of the present disclosure.

FIG. 3 illustrates a simplified diagram showing a method for verifying a software product using a software-supply-chain-provenance verification service, according to certain embodiments of the present disclosure.

FIG. 4 illustrates an example system for verifying a software product using a software-supply-chain-provenance verification service, according to certain embodiments of the present disclosure.

FIG. 5 illustrates a simplified diagram showing a computing system for verifying a software product using a software-supply-chain-provenance verification service, according to certain embodiments of the present disclosure.

### DETAILED DESCRIPTION

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

Although illustrative methods may be represented by one or more drawings (e.g., flow diagrams, communication flows, etc.), the drawings should not be interpreted as implying any requirement of, or particular order among or between, various steps disclosed herein. However, some embodiments may require certain steps and/or certain orders between certain steps, as may be explicitly described herein and/or as may be understood from the nature of the steps themselves (e.g., the performance of some steps may depend on the outcome of a previous step). Additionally, a “set,” “subset,” or “group” of items (e.g., inputs, algorithms, data values, etc.) may include one or more items and, similarly, a subset or subgroup of items may include one or more items. A “plurality” means more than one.

As used herein, the term “based on” is not meant to be restrictive, but rather indicates that a determination, identification, prediction, calculation, and/or the like, is performed by using, at least, the term following “based on” as an input. For example, predicting an outcome based on a particular piece of information may additionally, or alternatively, base the same determination on another piece of information. As used herein, the term “receive” or “receiving” means obtaining from a data repository (e.g., database), from another system or service, from another software, or from another software component in a same software. In certain embodiments, the term “access” or “accessing” means retrieving data or information, and/or generating data or information.

Conventional systems and methods are often not capable of effectively verifying a software product using a software-supply-chain-provenance verification service as described herein. Conventional systems and methods typically occur at a point of installation where any software that is in a trusted artifact store is installed, regardless of how it got there (e.g., which does not account for the software being stored there as a result of potential malicious acts). Further, in deployment heterogenous environments, these conventional techniques require adapting each deployment software of a plurality of different deployment software responsible for installation to be able to perform a verification. Adapting such deployment software can be complex, fraught with implementation errors, and cannot scale as the number of unique deployment environments grows.

Various embodiments of the present disclosure can achieve benefits and/or improvements by a computing system implementing one or more verification functionality and/or interacting with deployment environments. In some embodiments, benefits include significant improvements, including, for example, centrally maintaining deployment installation states of software products or artifacts thereof. In some embodiments, benefits include enforcing security policies that require supply-chain-provenance verification to pass for a given software product, before the given software product can be installed. In some embodiments, benefits include flexibility for addressing different deployment risk acceptance levels, such as depending on configurations or factors for specific tenants. In some embodiments, by moving supply-chain-provenance verification to a centralized deployment management system, supply-chain-provenance verification services can more easily and effectively be applied to a plurality of heterogeneous environments.

According to some embodiments, a software-supply-chain-provenance verification service is provided. In some embodiments, the software-supply-chain-provenance verification service, generally, is a service that performs a series of steps when writing, testing, packaging, and/or distributing software. In some embodiments, a software-supply-chain is composed of multiple steps that transform (e.g., via compilation) or verify a state (e.g., via linting) of a project in order to drive it to a final product (e.g., software product). In some embodiments, supply chain security contributes to overall security of a software product. For example, an attacker who is able to control a step in a supply chain may be able to alter a product for malicious intents that range from introducing backdoors in a source code to including vulnerable libraries in a final product.

In some embodiments, the software-supply-chain-provenance verification service ensures integrity of a software product from initiation to end-user installation, such as by making transparent to users what steps were performed, by whom/what and in what order to a package. In some embodiments, with some guidance from a group creating the software, the software-supply-chain-provenance verification service allows a user to verify if a step in the supply chain was intended to be performed, and if the step was performed by the right actor (e.g., the right individual, component and/or set of instructions stored in one or more memories of a device).

In some embodiments, the software-supply-chain-provenance verification service includes information of one or more artifacts. In some embodiments, the one or more artifacts are retrieved based on one or more bytes of metadata (e.g., provenance metadata) associated with a software product. In some embodiments, an artifact is a byproduct of software development that helps describe an architecture, design, and/or function of software. In some embodiments, artifacts are components that software developers can use to trace an entire software development process. In some embodiments, artifacts may include, for example, databases, data models, documents, and/or scripts.

In some embodiments, provenance metadata includes information concerning the creation, attribution, or version history of managed data. In some embodiments, the provenance metadata indicates the relationship between two versions of data objects and is generated whenever a new version of a data object is created.

In some embodiments, verifying a software product can rely, at least in part, on an open source framework. In some embodiments, verifying a software product may occur at a point of installation. In some embodiments, the software-supply-chain-provenance verification service may be implemented for cloud connected deployments. In some embodiments, environments discussed herein may be at least one of a deployment environment, a testing environment, a production environment, a beta environment, or another type of environment that may be recognized by those of ordinary skill in the art.

In some embodiments, environments discussed herein may be environments with specific requirements, such as an environment that does not allow specific software licenses (e.g., general public licenses, viral software licenses, etc.). In some embodiments, environments discussed herein may requires that specific types of software are not allowed into the environment. Accordingly, release channels that are configured to deploy software products into one or more environments may have requirements that restrict software products from being deployed to an environment based on the type of environment (e.g., testing environment, production environment, beta environment, restricted environment).

In some embodiments, in deployment heterogenous environments verifying software products at the point of installation requires adapting different deployment software responsible for installations to be able to perform verification. In some embodiments, adapting the deployment software can be complex, fraught with implementation errors, and may not scale as a number of unique deployment environments grows. In some embodiments, instead, a system is provided that centrally maintains deployment installation states that can be used enforce a security policy that requires a piece of software to pass verification (e.g., via a software-supply-chain-provenance verification service) before the piece of software can be installed.

In some embodiments, the security policy is a set of rules and/or requirements for an environment and/or a release channel that corresponds to the environment. In some embodiments, the security policy may require a degree of confidence (e.g., greater than a predetermined threshold) that a software product satisfies the parameters of an environment to which the software product is requested to be deployed. In some embodiments, the security policy may require a degree of confidence (e.g., greater than a predetermined threshold) that a software product satisfies the parameters of a release channel through which a software product is requested to be deployed. In some embodiments, rules and/or requirements within the set of rules and/or requirements may be ranked such that a software product may be released if it satisfies certain rules and/or requirements that are deemed to be relatively more important than other rules and/or requirements.

In some embodiments, the software-supply-chain-provenance verification service is responsible for performing an actual verification and reporting to the deployment management system the result of that verification. In some embodiments, the deployment management system saves the verification result as metadata about the software product on which the verification was performed. In some embodiments, the software-supply-chain-provenance verification service receives a specific product identifier and version to validate from the deployment management system. In some embodiments, the software-supply-chain-provenance verification service then performs validation by retrieving all associated artifacts and metadata. In some embodiments, software-supply-chain-provenance verification service sends the result of the verification, the product identifier, and the product version back to the deployment management system for storage. In some embodiments, the deployment management system applies a security policy which requires all products to have passed provenance verification in order to be installed. In some embodiments, policies associated with the provenance verification can be configured on a per deployment basis which allows for granular control of where provenance verification is enforced (e.g., on which deployment channels and/or in which environments).

In some embodiments, implementation described herein have several advantages. Additional and/or alternative advantages may be recognized by those of ordinary skill in the art. In some embodiments, the deployment management system can guarantee supply chain provenance of the software it is cataloging. In some embodiments, the deployment management system can offer to enforce that provenance be valid before installation. In some embodiments, a deployment management system can install any software that is in its trusted artifact store regardless of how it got to the artifact store. In some embodiments, implementations described herein capture a provenance verification status which proves that software has come through an expected source control and continuous integration (CI) systems prior to being published to the artifact storage. In some embodiments, implementation described herein provide flexibility for addressing different deployment risk acceptance levels. In some embodiments, a one size fits all security policy can block quick iteration and testing in places where developers need flexibility.

In some embodiments, by providing functionality for selecting what environments enforce the provenance verification, the deployment management system allows for, at minimum, bifurcation of risk acceptance of supply chain provenance. In some embodiments, a deployment management system can manage a diverse set of deployment environments such as, for example, on-premise bare metal hardware, cloud virtual machines (VMs), cloud platform as a service (PaaS), internet of things (IOT), internet connection sharing (ICS).

In some embodiments, to implement the software-supply-chain-provenance verification service for each of the deployment environments the environment specific software installation manager is adapted to perform provenance verification. In some embodiments, it may not be possible to adapt environment specific software installation managers to perform provenance verification because it may not be plausible to do for certain environments, such as IoT or ICS, due to hardware constraints and/or a lack of software malleability. In some embodiments, by moving the provenance verification to the deployment management system the provenance verification is offloaded and centralized so that it can equitably and trivially applied to all environments regardless of their limitations.

In some embodiments, the deployment management system may be used to validate software supply chain provenance (e.g., via the software-supply-chain-provenance verification service) of all software that it deploys. In some embodiments, leveraging flexible security policies within the deployment management system allows for enforcement of additional security controls (e.g., which may be configured by a system and/or user). In some embodiments, the software-supply-chain-provenance verification service can be used to require the completion of security controls upstream in a software supply chain.

It should be recognized that mechanisms disclosed herein may be used by a plurality of different software applications, in manners that will be recognized by those of ordinary skill in the art.

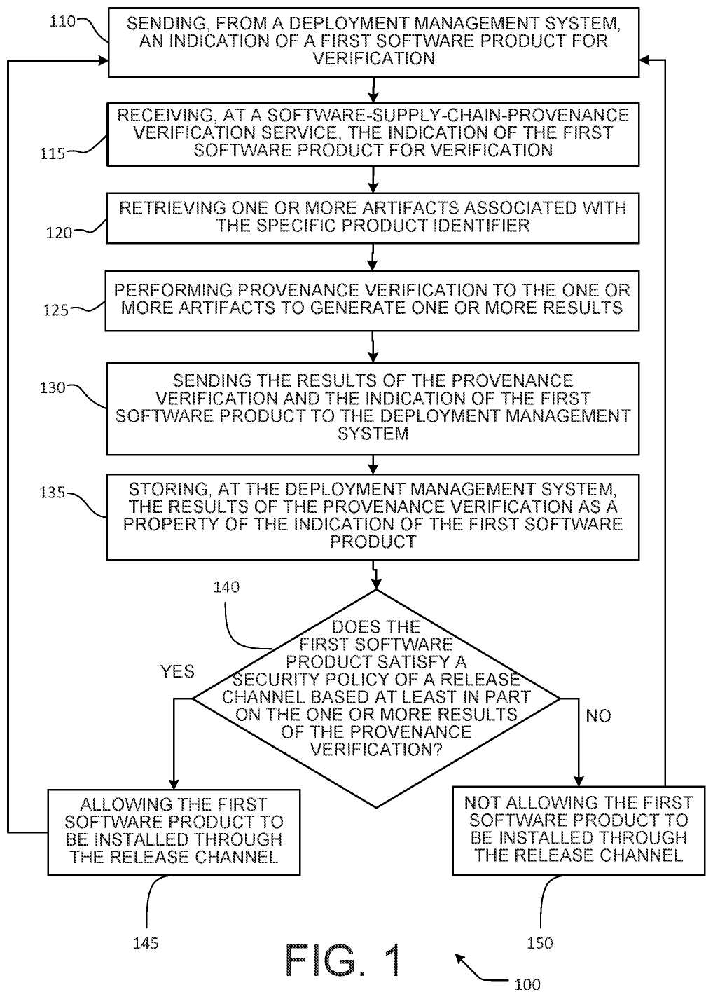

FIG. 1 is a simplified diagram showing a method 100 for verifying a software product using a software-supply-chain-provenance verification service according to certain embodiments of the present disclosure. This diagram is merely an example. One of ordinary skill in the art would recognize many variations, alternatives, and modifications. The method 100 for verifying a software product using a software-supply-chain-provenance verification service includes processes 110, 115, 120, 125, 130, 135, 140, and 145. Although the above has been shown using a selected group of processes for the method 100 for verifying a software product using a software-supply-chain-provenance verification service, there can be many alternatives, modifications, and variations. For example, some of the processes may be expanded and/or combined. Other processes may be inserted into those noted above. Depending upon the embodiments, the sequence of processes may be interchanged with others replaced. Further details of these processes are found throughout the present disclosure.

According to some embodiments, at the process 110, an indication of a first software product is sent from a deployment management system for verification. In some embodiments, the indication may correspond to a specific software product (e.g., a software application and/or a piece of software). In some embodiments, the indication may include an indication of a version of the first software (e.g., a first version, a second version, a third version).

According to some embodiments, at the process 115, the indication of the first software product for verification is received at a software-supply-chain-provenance verification service. In some embodiments, the software-supply-chain-provenance verification service may be at least partially implemented based on open-source software.

In some embodiments, a software-supply-chain-provenance verification service, generally, is a service that performs a series of steps when writing, testing, packaging, and distributing software. In some embodiments, a software supply chain is composed of multiple steps chained together that transform (e.g., compilation) or verify a state (e.g., linting) of a project in order to drive it to a final product (e.g., software product). In some embodiments, supply chain security is crucial to overall security of a software product. For example, an attacker who is able to control a step in a supply chain may be able to alter a product for malicious intents that range from introducing backdoors in a source code to including vulnerable libraries in a final product.

In some embodiments, the software-supply-chain-provenance verification service ensures integrity of a software product from initiation to end-user installation, such as by making transparent to users what steps were performed, by whom and in what order to a package. In some embodiments, with some guidance from a group creating the software, the software-supply-chain-provenance verification service allows a user to verify if a step in the supply chain was intended to be performed, and if the step was performed by the right actor.

According to some embodiments, at the process 120, one or more artifacts associated with the first software product for verification are retrieved. In some embodiments, the one or more artifacts are retrieved based on one or more bytes of metadata associated with the first software product. In some embodiments, an artifact is a byproduct of software development that helps describe an architecture, design, and/or function of software. In some embodiments, artifacts are components that software developers can use to trace an entire software development process. In some embodiments, artifacts may include, for example, databases, data models, documents, and/or scripts.

According to some embodiments, at the process 125, provenance verification is performed to the one or more artifacts to generate one or more results. In some embodiments, the results of the provenance verification service include a provenance verification status which indicates whether the first software product does or does not pass the provenance verification. In some embodiments, the results of the provenance verification service further include information corresponding to a specific software that generated the first software product for verification (e.g., what open-source software has been used in the process of creating the software that has the specific product identifier and version).

According to some embodiments, at the process 130, the results of the provenance verification and the corresponding verification specific identifier and version are sent to the deployment management system. In some embodiments, the results are automatically sent to the deployment management system. In some embodiments, the results are sent in response to a request by the deployment management system to receive the results of the provenance verification.

According to some embodiments, at the process 135, the results of the provenance verification are stored as a property of the corresponding specific product identifier and version. In some embodiments, the deployment management system may be a centralized system that catalogues products and their corresponding provenance verification results such that users and/or other systems may reference the deployment management system to determine if a product has been verified.

According to some embodiments, at the process 140, it is determined whether the first software product satisfies a security policy of a release channel based at least in part on the one or more results of the provenance verification. In some embodiments, it is determined that the first software product does satisfy a security policy of a release channel based at least in part on the one or more results of the provenance verification. In some embodiments, it is determined that the first software product does not satisfy a security policy of a release channel based at least in part on the one or more results of the provenance verification.

In some embodiments, the release channel is selected from a plurality of release channels. In some embodiments, at least two release channels of the plurality of release channels have different security policies. In some embodiments, each of the release channels of the plurality of release channels have different security policies.

In some embodiments, the security policy requires that the specific product identifier must pass the provenance verification. In some embodiments, the security policy requires that the product corresponding to the specific product identifier was not generated using a specific software (e.g., that certain open-source software was not used in the process of creating the software).

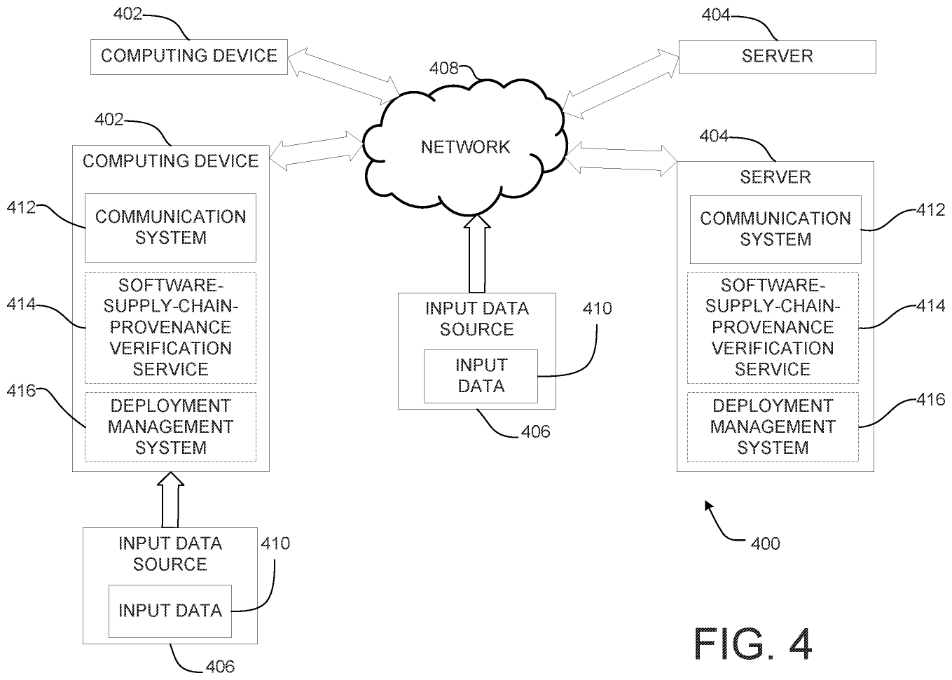

According to some embodiments, at the process 145, the first software product may be allowed to be installed through the release channel. In some embodiments, the first software product may be allowed to be installed, via the deployment management system. In some embodiments, the first software product may be allowed to be installed in response to determining that the first software product satisfies a security policy of a release channel based at least in part on the one or more results of the provenance verification. In some embodiments, the first software product may be deployed through the release channel. In some embodiments, the first software product is installed to a computing device, such as computing device 402 discussed below with respect to FIG. 4. In some embodiments, the first software product is installed to a server, such as server 402 discussed below with respect to FIG. 4. In some embodiments, the first software product is installed to an environment being executed on at least one of the computing device and the server.

In some embodiments, method 100 may terminate at process 145. In some embodiments, method 100 may return to process 110 (or any other process from method 100) to provide an iterative loop, such as of sending a first software product for verification, determining whether the first software product satisfies a security policy of a release channel based at least in part on the results of provenance verification, and allowing or not allowing for the first software product to be deployed, depending on the determination of whether the first software product satisfies the security policy of the release channel.

According to some embodiments, at the process 150, the first software product may not be allowed to be installed through the release channel. In some embodiments, the first software product may not be allowed to be installed, via the deployment management system. In some embodiments, the first software product may not be allowed to be installed in response to determining that the first software product does not satisfy a security policy of a release channel based at least in part on the one or more results of the provenance verification.

In some embodiments, method 100 may terminate at process 150. In some embodiments, method 100 may return to process 110 (or any other process from method 100) to provide an iterative loop, such as of sending a first software product for verification, determining whether the first software product satisfies a security policy of a release channel based at least in part on the results of provenance verification, and allowing or not allowing for the first software product to be deployed, depending on the determination of whether the first software product satisfies the security policy of the release channel.

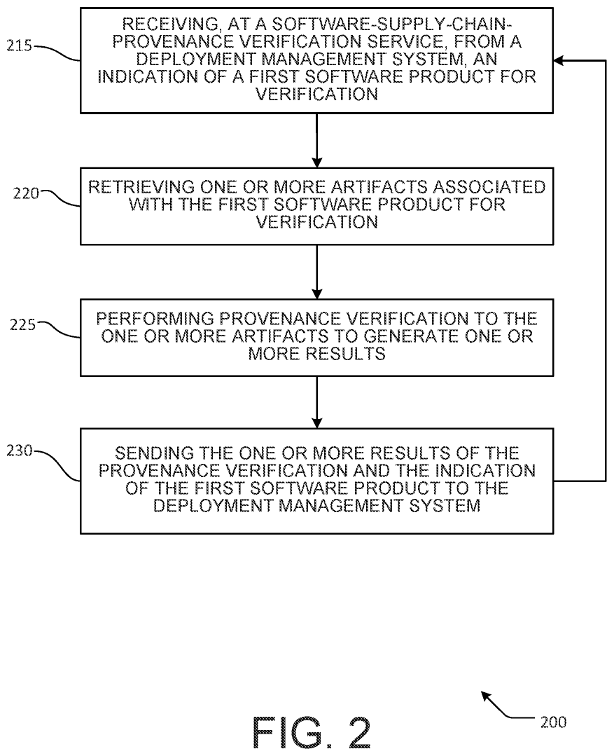

FIG. 2 is a simplified diagram showing a method 200 for verifying a software product using a software-supply-chain-provenance verification service according to certain embodiments of the present disclosure. This diagram is merely an example. One of ordinary skill in the art would recognize many variations, alternatives, and modifications. The method 200 for verifying a software product using a software-supply-chain-provenance verification service includes processes 215, 220, 225, and 230. Although the above has been shown using a selected group of processes for the method 200 for verifying a software product using a software-supply-chain-provenance verification service, there can be many alternatives, modifications, and variations. For example, some of the processes may be expanded and/or combined. Other processes may be inserted into those noted above. Depending upon the embodiments, the sequence of processes may be interchanged with others replaced. Further details of these processes are found throughout the present disclosure.

According to some embodiments, at the process 215, at a software-supply-chain-provenance verification service, an indication of a first software product for verification is received from a deployment management system. In some embodiments, the first software product is associated with a version (e.g., a first version, a second version, a third version).

According to some embodiments, at the process 220, one or more artifacts associated with the first product for verification are retrieved. In some embodiments, the one or more artifacts are retrieved based on one or more bytes of metadata associated with the first software product. In some embodiments, an artifact is a byproduct of software development that helps describe an architecture, design, and/or function of software. In some embodiments, artifacts are components that software developers can use to trace an entire software development process. In some embodiments, artifacts may include, for example, databases, data models, documents, and/or scripts.

According to some embodiments, at the process 225, provenance verification is performed to the one or more artifacts to generate one or more results. In some embodiments, the one or more results of the provenance verification service comprise a provenance verification status which indicates whether the first software product does or does not pass the provenance verification. In some embodiments, the one or more results of the provenance verification service further comprise information corresponding to a second software used in the first software product for verification. In some embodiments, the second software is an open-source software, a software manufactured by a specific manufacturer, and/or a software associated with a specific software license.

According to some embodiments, at the process 230, the one or more results of the provenance verification and the indication of the first software product are sent to the deployment management system.

In some embodiments, the deployment management system is configured to determine whether the first software product satisfies a security policy of a release channel based at least in part on the one or more results of the provenance verification. In some embodiments, the security policy requires the first software product to pass the provenance verification. In some embodiments, the deployment management system is further configured to, in response to the first software product being determined to satisfy the security policy, allow for the first software product to be installed through the release channel.

In some embodiments, the security policy further requires that the first software product does not include a piece of software associated with a specific software license. In some embodiments, the release channel is selected from a plurality of release channels, and wherein at least two release channels of the plurality of release channels have different security policies.

In some embodiments, the deployment management system is further configured to, in response to the first software product being determined to not satisfy the security policy, not allowing for the first software product to be installed through the release channel.

In some embodiments, method 200 may terminate at process 230. In some embodiments, method 200 may return to process 215 (or any other process from method 200) to provide an iterative loop, such as of receiving an indication of a first software product for verification, performing provenance verification, and sending one or more results of the provenance verification and the indication of the first software product to a deployment management system.

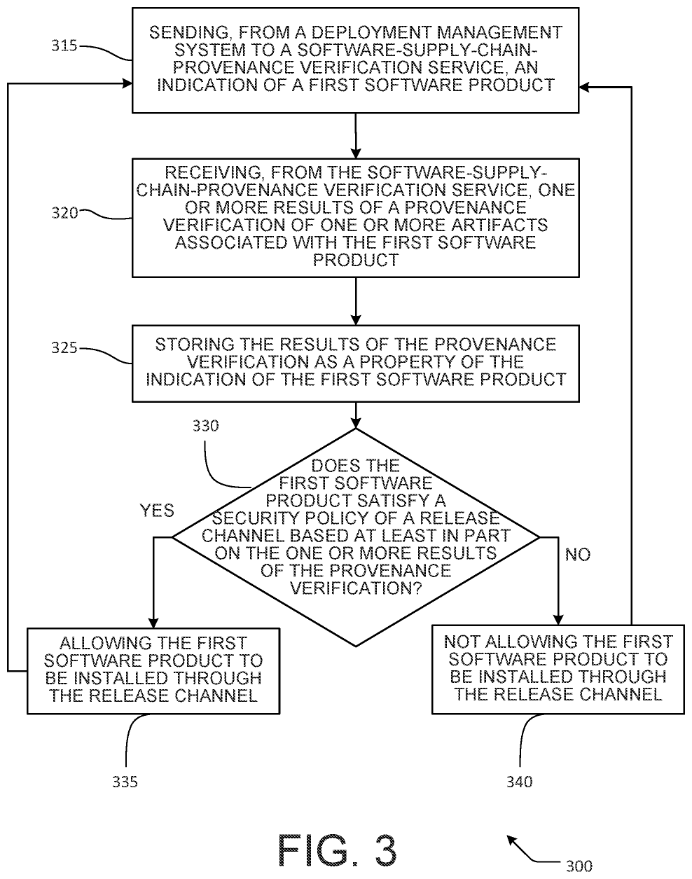

FIG. 3 is a simplified diagram showing a method 300 for verifying a software product using a software-supply-chain-provenance verification service according to certain embodiments of the present disclosure. This diagram is merely an example. One of ordinary skill in the art would recognize many variations, alternatives, and modifications. The method 300 for verifying a software product using a software-supply-chain-provenance verification service includes processes 315, 320, 325, and 330. Although the above has been shown using a selected group of processes for the method 300 for verifying a software product using a software-supply-chain-provenance verification service, there can be many alternatives, modifications, and variations. For example, some of the processes may be expanded and/or combined. Other processes may be inserted into those noted above. Depending upon the embodiments, the sequence of processes may be interchanged with others replaced. Further details of these processes are found throughout the present disclosure.

According to some embodiments, at the process 315, an indication of a first software product is sent from a deployment management system to a software-supply-chain-provenance verification service. In some embodiments, the first software product is associated with a version (e.g., a first version, a second version, a third version).

According to some embodiments, at the process 320, one or more results of a provenance verification of one or more artifacts associated with the first software product is received from the software-supply-chain-provenance verification service. In some embodiments, the one or more results of the provenance verification service include a provenance verification status which indicates whether the first software product does or does not pass the provenance verification. In some embodiments, the one or more results of the provenance verification service further comprise information corresponding to a second software used in the first software product for verification. In some embodiments, the second software is an open-source software, a software manufactured by a specific manufacturer, and/or a software associated with a specific software license.

In some embodiments, the one or more artifacts are retrieved based on one or more bytes of metadata associated with the first software product. In some embodiments, the artifacts are components that are packaged to form, at least in part, the first software package. In some embodiments, an artifact is a byproduct of software development that helps describe an architecture, design, and/or function of software. In some embodiments, artifacts are components that software developers can use to trace an entire software development process. In some embodiments, artifacts may include, for example, databases, data models, documents, and/or scripts. In some embodiments, the metadata includes information concerning the creation, attribution, or version history of managed data.

According to some embodiments, at the process 325, the results of the provenance verification are stored as a property of the indication of the first software product. In some embodiments, the results of the provenance verification are stored as a property of the first software product. In some embodiments, the results of the provenance verification are stored as bytes corresponding to metadata of the first software product.

According to some embodiments, at the process 330, it is determined whether the first software product satisfies a security policy of a release channel based at least in part on the one or more results of the provenance verification. In some embodiments, the release channel is selected from a plurality of release channels, and at least two release channels of the plurality of release channels have different security policies.

In some embodiments, the security policy requires the first software product to pass the provenance verification. In some embodiments, the security policy further requires that the first software product does not include a piece of software associated with a specific software license. In some embodiments, the first software product is associated with a version.

If the first software product does satisfy the security policy, flow advances to process 335. If the first software product does not satisfy the security policy, flow advances to process 340.

According to some embodiments, at the process 335, the first software product may be allowed to be installed through the release channel. In some embodiments, the first software product may be allowed to be installed, via the deployment management system. In some embodiments, the first software product may be allowed to be installed in response to determining that the first software product satisfies a security policy of a release channel based at least in part on the one or more results of the provenance verification. In some embodiments, the first software product may be deployed through the release channel. In some embodiments, the first software product is installed to a computing device, such as computing device 402 discussed below with respect to FIG. 4. In some embodiments, the first software product is installed to a server, such as server 402 discussed below with respect to FIG. 4. In some embodiments, the first software product is installed to an environment being executed on at least one of the computing device and the server.

In some embodiments, method 300 may terminate at process 335. In some embodiments, method 300 may return to process 315 (or any other process from method 300) to provide an iterative loop, such as of sending a first software product for verification, determining whether the first software product satisfies a security policy of a release channel based at least in part on the results of provenance verification, and allowing or not allowing for the first software product to be deployed, depending on the determination of whether the first software product satisfies the security policy of the release channel.

According to some embodiments, at the process 340, the first software product may not be allowed to be installed through the release channel. In some embodiments, the first software product may not be allowed to be installed, via the deployment management system. In some embodiments, the first software product may not be allowed to be installed in response to determining that the first software product does not satisfy a security policy of a release channel based at least in part on the one or more results of the provenance verification.

In some embodiments, method 300 may terminate at process 340. In some embodiments, method 300 may return to process 315 (or any other process from method 300) to provide an iterative loop, such as of sending a first software product for verification, determining whether the first software product satisfies a security policy of a release channel based at least in part on the results of provenance verification, and allowing or not allowing for the first software product to be deployed, depending on the determination of whether the first software product satisfies the security policy of the release channel.

FIG. 4 shows an example of a system 400, in accordance with some aspects of the disclosed subject matter. In some embodiments, the system 400 is a system for verifying a software product using a software-supply-chain-provenance verification service. FIG. 4 is merely an example. One of the ordinary skilled in the art would recognize many variations, alternatives, and modifications. Although system 400 has been shown using a selected group of components, there can be many alternatives, modifications, and variations. For example, some of the components may be expanded and/or combined. Other components may be inserted into those noted above. Depending upon the example, the arrangement of components may be interchanged with others replaced. Further details of these components are found throughout the present disclosure.

In some embodiments, various components in the system 400 can execute software or firmware stored in non-transitory computer-readable medium to implement various processing steps. In some embodiments, various components and processors of the system 400 can be implemented by one or more computing devices including, but not limited to, circuits, a computer, a cloud-based processing unit, a processor, a processing unit, a microprocessor, a mobile computing device, and/or a tablet computer. In some embodiments, various components of the system 400 can be implemented on a shared computing device. In some embodiments, a component of the system 400 can be implemented on multiple computing devices. In some embodiments, various modules and components of the system 400 can be implemented as software, hardware, firmware, or a combination thereof.

In some embodiments, the system 400 includes one or more computing devices 402, one or more servers 404, one or more input data sources 406, and a communication network or network 408. In some embodiments, the computing device 402 can receive input data 410 from the input data source 406. Additionally, or alternatively, in some embodiments, the network 408 can receive input data 410 from the input data source 406.

In some embodiments, computing device 402 includes a communication system 412, software-supply-chain-provenance verification service or component 414, and/or a deployment management system or component 416. In some embodiments, computing device 402 can execute at least a portion of the software-supply-chain provenance verification service 414 to perform provenance verification based on an indication of a software product (e.g., corresponding to a specific product identifier and version for verification). In some embodiments, the software-supply-chain provenance verification service 414 retrieves one or more artifacts corresponding to the software product to generate results for the provenance verification. In some embodiments, the computing device 402 can execute at least a portion of the deployment management system 416 to send the software product or indication thereof for the provenance verification. In some embodiments, the deployment management system 416 stores the results of provenance verification, determines whether a software product satisfies a security policy of a release channel, and either allows or does not allow for the software product to be deployed and/or installed based on whether the security policy is satisfied.

In some embodiments, the software-supply-chain-provenance verification service 414 may be part of the deployment management system 416. In some embodiments, the software-supply-chain-provenance verification service 414 may be separate from the deployment management system 416. In some embodiments, at least a portion of the software-supply-chain-provenance verification service 414 and the deployment management system 416 may be implemented on the same device. In some embodiments, at least a portion of the software-supply-chain-provenance verification service 414 and the deployment management system 416 may be implemented on different devices.

In some embodiments, server 404 includes a communication system 412, software-supply-chain-provenance verification service or component 414, and/or a deployment management system or component 416. In some embodiments, server 404 can execute at least a portion of the software-supply-chain provenance verification service 414 to perform provenance verification based on an indication of a software product (e.g., corresponding to a specific product identifier and version for verification). In some embodiments, the software-supply-chain provenance verification service 414 retrieves one or more artifacts corresponding to the software product to generate results for the provenance verification. In some embodiments, the server 404 can execute at least a portion of the deployment management system 416 to send the software product or indication thereof for the provenance verification. In some embodiments, the deployment management system 416 stores the results of provenance verification, determines whether a software product satisfies a security policy of a release channel, and either allows or does not allow for the software product to be deployed and/or installed based on whether the security policy is satisfied.

Additionally, or alternatively, in some embodiments, computing device 402 can communicate data received from input data source 406 to the server 404 over a communication network 408, which can execute at least a portion of the software-supply-chain-provenance verification service 414 and/or the deployment management system 416. In some embodiments, the software-supply-chain-provenance verification service 414 executes one or more portions of methods/processes disclosed herein and/or recognized by those of ordinary skill in the art, in light of the present disclosure. In some embodiments, the deployment management system 416 executes one or more portions of methods/processes disclosed herein and/or recognized by those of ordinary skill in the art, in light of the present disclosure.

In some embodiments, computing device 402 and/or server 404 can be any suitable computing device or combination of devices, such as a desktop computer, a vehicle computer, a mobile computing device (e.g., a laptop computer, a smartphone, a tablet computer, a wearable computer, etc.), a server computer, a virtual machine being executed by a physical computing device, a web server, etc. Further, in some embodiments, there may be a plurality of computing device 402 and/or a plurality of servers 404.

In some embodiments, input data source 406 can be any suitable source of input data (e.g., data generated from a computing device, data stored in a repository, data generated from a software application, etc.) In some embodiments, input data source 406 can include memory storing input data (e.g., local memory of computing device 402, local memory of server 404, cloud storage, portable memory connected to computing device 402, portable memory connected to server 404, etc.). In some embodiments, input data source 406 can include an application configured to generate input data and provide the input data via a software interface. In some embodiments, input data source 406 can be local to computing device 402. In some embodiments, input data source 406 can be remote from computing device 402, and can communicate input data 410 to computing device 402 (and/or server 404) via a communication network (e.g., communication network 408).

In some embodiments, the input data source 406 may include a repository that is implemented using any one of the configurations described below. In some embodiments, a data repository may include random access memories, flat files, XML files, and/or one or more database management systems (DBMS) executing on one or more database servers or a data center. In some embodiments, a database management system may be a relational (RDBMS), hierarchical (HDBMS), multidimensional (MDBMS), object oriented (ODBMS or OODBMS) or object relational (ORDBMS) database management system, and the like. In some embodiments, the data repository may be, for example, a single relational database. In some embodiments, the data repository may include a plurality of databases that can exchange and aggregate data by data integration process or software application. In some embodiments, at least part of the data repository may be hosted in a cloud data center. In some embodiments, a data repository may be hosted on a single computer, a server, a storage device, a cloud server, or the like. In some embodiments, a data repository may be hosted on a series of networked computers, servers, or devices. In some embodiments, a data repository may be hosted on tiers of data storage devices including local, regional, and central.

In some embodiments, the input data 410 may include a software product (e.g., a software application and/or a piece of software that includes partial instructions for a software application), an indication (e.g., identifier) of a software product, artifacts associated with the software product, and/or metadata associated with the software product.

In some embodiments, communication network 408 can be any suitable communication network or combination of communication networks. For example, communication network 408 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard), a wired network, etc. In some embodiments, communication network 408 can be a local area network (LAN), interfaces conforming known communications standard, such as Bluetooth® standard, IEEE 802 standards (e.g., IEEE 802.11), a ZigBee® or similar specification, such as those based on the IEEE 802.15.4 standard, a wide area network (WAN), a public network (e.g., the Internet), a private or semi-private network (e.g., a corporate or university intranet), any other suitable type of network, or any suitable combination of networks. In some embodiments, communication links (arrows) shown in FIG. 4 can each be any suitable communications link or combination of communication links, such as wired links, fiber optics links, Wi-Fi links, Bluetooth® links, cellular links, satellite links, etc.

In some embodiments, a security policy that enforces software supply chain provenance and artifact integrity is integrated for use with a deployment management system. In some embodiments, software supply chain provenance and artifact integrity refer to an ability to cryptographically prove that a piece of software has gone through a set of preordained steps that make up a software supply chain, and at the end of that produce an artifact that mechanisms can then show matches what is eventually going to be installed by the deployment management system on a particular deployment. In some examples, mechanisms described herein may be applied to any of a plurality of supply chain provenance frameworks.

In some embodiments, the deployment management system receives provenance information (e.g., from a software-supply-chain-provenance verification service) and stores that information as metadata about a piece of software that is to be deployed. In some embodiments, the deployment management system is able to make decisions on whether or not the software should be deployed and/or installed based on whether provenance for that specific software has or has not passed a verification.

Some embodiments described herein may be advantageous for a plurality of reasons. In some embodiments, the capabilities and tooling of deployment environments varies across deployment environment. In some embodiments, to apply a provenance track disclosed herein, mechanisms may have to modify the environment that software is being installed into to be able to perform the verification itself. In some embodiments that are resource constrained, the systems cannot be readily modified to perform a verification check for a variety of reasons. Accordingly, in some embodiments, it may be advantageous to move where a verification occurs up a level in the system and/or process.

In some embodiments, a provenance integrity check can be applied to any of a plurality of environments, such as a cloud environment, a local environment, an IOT environment, etc. In some embodiments, the provenance integrity check may be applied in a uniform way as opposed to having to modify every individual environment to perform provenance check. In some embodiments, the deployment management system is a centralized location where verification guarantees are made. In some embodiments, end users are able to set policies on how information is applied or filtered, and then the deployment management system is able to make decisions based on that information to provide guarantees about the software that it deploys.

In some embodiments, an advantage is that for the same software package, if mechanisms can verify its prognosis at a high level, then, then mechanisms do not have to make verifications about the software package again and again on installation basis. In some embodiments, systems and methods provided herein for verifying software packages streamline a verification process, by not requiring verification every time the software package is installed.

In some embodiments, verification information is recorded in a centralized catalog (e.g., recorded once in the deployment management system). In some embodiments, additional verifications may be performed later. In some embodiments, it is preferable to reverify again when installing software products to further improve security. In some embodiments, if you just verify a software product once at one point in time, but then install it later, if a hacker or malicious actor has modified the product in-between, it may be beneficial to reverify the software product when it is installed.

In some embodiments, the deployment management system centralizes the concept of a product. In some embodiments there may be multiple different versions of a product, such as a container version, a windows version, a macOS version, etc. The deployment management system may be able to store both the fact that a software product has been verified for one or more version. In some embodiments, other systems may access information stored in the deployment management system to perform its own verifications later. In some embodiments, the verification information stored by the deployment management system includes a hash string. In some embodiments, the verification information stored by the deployment management system includes rich metadata to be able to perform a verification and without a central location for storing this information (e.g., in the deployment management system), storing this metadata would not have been possible

In some embodiments, software can be categorized in different tiers based on release channels. In some embodiments, different release channels may be based on a different level of trust associated with a software.

In some embodiments, for local development, full resources might not be available, or for time efficiency, a bundle of an executable may be sent out but without creating all of the elements that are needed to verify it. In some embodiments, for a specific security channel it might be okay to not perform a verification or to have artifacts in the specific security channel that do not pass this verification, but for another security channel, anything in the channel must pass a verification.

In some embodiments, by having verification information registered centrally in a catalog, a piece of software can have associated metadata describing whether or not verification materials are available or whether it's gone through the verification process. In some embodiments, the centrally registered information includes a property and has data associated with that property, such that other parts of the system can then use that property to both follow the policy for what software to install and then also perform actions based on the information that is registered centrally.

In some embodiments, security policies are a policy for a channel. In some embodiments, products are not allowed into a channel unless certain conditions of the policy have been met. In some embodiments, the conditions can be configurable. In some embodiments, if the conditions are not met, the product will not be approved and so it cannot go into a channel. In some embodiments, the product may be able to go into a channel with different policy conditions but it cannot go into the channel with policy conditions for which it does not satisfy.

In some embodiments, the security policy may correspond to the security of an environment associated with one or more channels. For example, if customers require relatively high security, then the policies associated with channels uploading software to the customers may be relatively strict. As another example, if a software is being used internal to an organization, then the policies associated with channels uploading software the internal infrastructure may be relatively less strict. In some embodiments, security policies associated with a channel may correspond to the security of an environment to which software is being uploaded through the channel. In some embodiments, security policies may be based on client preference, such as whether a client would prefer software that is secure with a high degree of confidence, or software that is secure with a lower degree of confidence but is a newer version than software that the client has currently.

In some embodiments, methods described herein include an initial verification that will hold states corresponding to whether a verification passed at an initial period of a product entering a catalogue. In some embodiments, a verification may be performed again when a product is actually installed and deployed. In some embodiments, the verification may be performed on a continuous basis for anything that's deployed. Those of ordinary skill in the art will recognize that increases the frequency of verifications may increase a confidence in security that the product has not been tampered with in some way.

In some embodiments, systems disclosed herein guarantee how software has been built as part of a security policy. For example, for a given build artifact systems disclosed herein can prove to that three different systems all built the artifact. In some embodiments, data associated with a software product will include dependencies and may have metadata like licenses. In some embodiments, software products associated with certain licenses may be granted or denied the ability to be deployed based on policies related to the licenses. In some embodiments, software products that have been written, at least in part, by certain systems or organizations may be granted or denied the ability to be deployed based on policies regarding the systems or organizations. In some embodiments, different channels may have different configurable policies depending on which licenses and/or organizations related to software products are acceptable for a given channel. In some embodiments, information associated with a software product (e.g., that may be relied on by policies for a given channel) may include at what time it was built, were materials that contributed to the software product originated, what were the materials that contributed to the software product, etc.

In some embodiments, certain deployments can choose to which channels they subscribe. In some embodiments, specific environments may be relatively more permissive for risk regarding to which channels they will subscribe.

In some embodiments, the deployment management system provides the ability to respond to future failures in a provenance check. In some embodiments, if an artifact to be deployed has been compromised (e.g., something about the artifact has been maliciously or otherwise altered) and the verification fails, mechanisms described herein may obtain an uncompromised version of the software product from the deployment management system because it is a centralized management system of what is to be deployed.

In some embodiments, software products may be automatically upgraded or replaced. For example, in some embodiments, if a policy no longer allows software with dependencies relating to a license that is no longer allowed, systems described herein may migrate the software product to a version that aligns with the policy. In some embodiments, even if compliance requirements whether they be security or legal or organization change in the future, not only can the system detect and enforce that but it also by virtue of the other parts of the deployment management system, it can automatically remediate and migrate to other versions that pass the compliance requirements. In some embodiments, metadata that is registered with a product in the centralized deployment management system can correspond to upgrade paths to other versions of the product that satisfy certain compliance and/or policy checks.

In some embodiments, when applying the software-supply-chain-provenance-verification service, an artifact or piece of software may be deployed to a particular channel and metadata may be analyzed to determine if the artifact or piece of software passes all of the verification and policy checks associated with the channel. In some embodiments, if the artifact or piece of software fails the verification or policy checks, systems disclosed herein may flag that failure. In some embodiments, after flagging the failure, systems disclosed herein may provide an indication corresponding to a need to update or repackage the software product. In some embodiments, after flagging the failure, systems disclosed herein may automatically update and/or find a previously-packaged version of the software product that is known to comply with policy requirements.

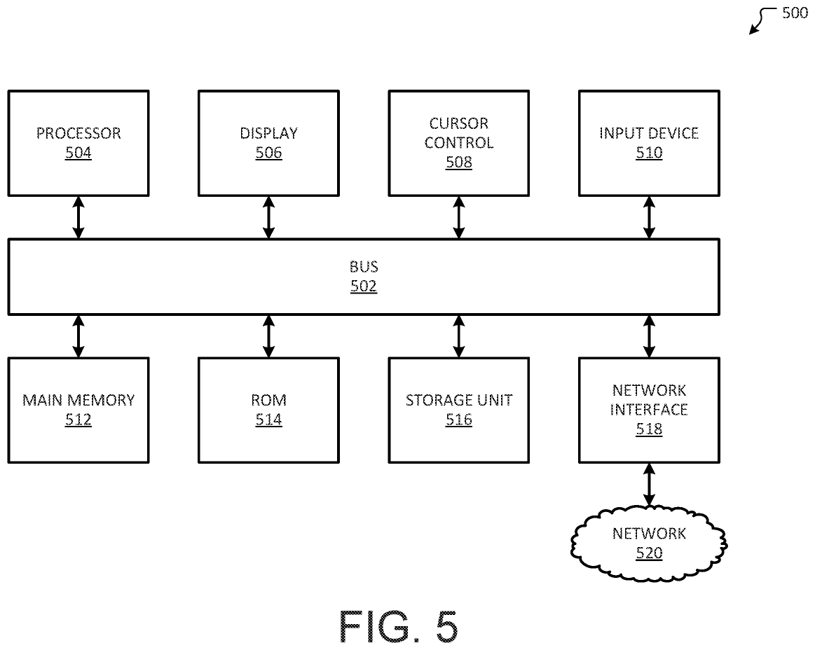

FIG. 5 is a simplified diagram showing a computing system for implementing a system 500 for verifying a software product using a software-supply-chain-provenance verification service in accordance with at least one example set forth in the disclosure. This diagram is merely an example, which should not unduly limit the scope of the claims. One of ordinary skill in the art would recognize many variations, alternatives, and modifications.

The computing system 500 includes a bus 502 or other communication mechanism for communicating information, a processor 504, a display 506, a cursor control component 508, an input device 510, a main memory 512, a read only memory (ROM) 514, a storage unit 516, and a network interface 518. In some embodiments, some or all processes (e.g., steps) of methods and/or processes disclosed herein are performed by the computing system 500. In some embodiments, the bus 502 is coupled to the processor 504, the display 506, the cursor control component 508, the input device 510, the main memory 512, the read only memory (ROM) 514, the storage unit 516, and/or the network interface 518. In certain embodiments, the network interface is coupled to a network 520. For example, the processor 504 includes one or more general purpose microprocessors. In some embodiments, the main memory 512 (e.g., random access memory (RAM), cache and/or other dynamic storage devices) is configured to store information and instructions to be executed by the processor 504. In certain embodiments, the main memory 512 is configured to store temporary variables or other intermediate information during execution of instructions to be executed by processor 504. For example, the instructions, when stored in the storage unit 516 accessible to processor 504, render the computing system 500 into a special-purpose machine that is customized to perform the operations specified in the instructions. In some embodiments, the ROM 514 is configured to store static information and instructions for the processor 504. In certain embodiments, the storage unit 516 (e.g., a magnetic disk, optical disk, or flash drive) is configured to store information and instructions.

In some embodiments, the display 506 (e.g., a cathode ray tube (CRT), an LCD display, or a touch screen) is configured to display information to a user of the computing system 500. In some embodiments, the input device 510 (e.g., alphanumeric and other keys) is configured to communicate information and commands to the processor 504. For example, the cursor control component 508 (e.g., a mouse, a trackball, or cursor direction keys) is configured to communicate additional information and commands (e.g., to control cursor movements on the display 506) to the processor 504.

According to certain embodiments, a method for verifying a software product using a software-supply-chain-provenance verification service is provided. The method includes: receiving, at the software-supply-chain-provenance verification service from a deployment management system, an indication of a first software product for verification; retrieving one or more artifacts associated with the first software product for verification; performing provenance verification to the one or more artifacts to generate one or more results; sending the one or more results of the provenance verification and the indication of the first software product to the deployment management system, wherein the deployment management system is configured to: determine whether the first software product satisfies a security policy of a release channel based at least in part on the one or more results of the provenance verification; and in response to the first software product being determined to satisfy the security policy, allow for the first software product to be installed through the release channel. The method is performed using one or more processors. For example, the method is implemented according to at least FIG. 1, FIG. 2, FIG. 3, and/or FIG. 4.

In some embodiments, the results of the provenance verification service comprise a provenance verification status which indicates whether the first software product does or does not pass the provenance verification. In some embodiments, the results of the provenance verification service further comprise information corresponding to a specific software that generated the first software product for verification.

In some embodiments, the release channel is selected from a plurality of release channels, and at least two release channels of the plurality of release channels have different security policies. In some embodiments, the security policy requires the first software product to pass the provenance verification. In some embodiments, the security policy further requires that the first software product does not include a piece of software associated with a specific software license.

In some embodiments, the first software product is associated with a version. In some embodiments, the deployment management system is further configured to: in response to the first software product being determined to not satisfy the security policy, not allowing for the first software product to be installed through the release channel. In some embodiments, the one or more artifacts are retrieved based on one or more bytes of metadata associated with the first software product.

According to certain embodiments, a method for verifying a software product using a software-supply-chain-provenance verification service is provided. The method includes: sending, from a deployment management system to a software-supply-chain-provenance verification service, an indication of a first software product; receiving, from the software-supply-chain-provenance verification service, one or more results of a provenance verification of one or more artifacts associated with the first software product; storing the results of the provenance verification as a property of the indication of the first software product; determining whether the first software product satisfies a security policy of a release channel based at least in part on the one or more results of the provenance verification; and in response to the first software product being determined to satisfy the security policy, allowing for the first software product to be installed through the release channel. The method is performed using one or more processors. For example, the method is implemented according to at least FIG. 1, FIG. 2, FIG. 3, and/or FIG. 4.

In some embodiments, the results of the provenance verification service comprise a provenance verification status which indicates whether the first software product does or does not pass the provenance verification. In some embodiments, the results of the provenance verification service further comprise information corresponding to a specific software that generated the first software product for verification.

In some embodiments, the release channel is selected from a plurality of release channels, and at least two release channels of the plurality of release channels have different security policies. In some embodiments, the security policy requires the first software product to pass the provenance verification. In some embodiments, the security policy further requires that the first software product does not include a piece of software associated with a specific software license.

In some embodiments, the first software product is associated with a version. In some embodiments, the deployment management system is further configured to: in response to the first software product being determined to not satisfy the security policy, not allowing for the first software product to be installed through the release channel. In some embodiments, the one or more artifacts are retrieved based on one or more bytes of metadata associated with the first software product.

According to certain embodiments, a system for verifying a software product using a software-supply-chain-provenance verification service is provided. The system includes: a processor; and memory storing instructions that, when executed by the processor, cause the system to perform a set of operations. The set of operations include: sending, from a deployment management system to a software-supply-chain-provenance verification service, an indication of a first software product; receiving, from the software-supply-chain-provenance verification service, one or more results of a provenance verification of one or more artifacts associated with the first software product; storing the results of the provenance verification as a property of the indication of the first software product; determining whether the first software product satisfies a security policy of a release channel based at least in part on the one or more results of the provenance verification; and in response to the first software product being determined to satisfy the security policy, allowing for the first software product to be installed through the release channel. For example, the system is implemented according to at least FIG. 1, FIG. 2, FIG. 3, and/or FIG. 4.

In some embodiments, the results of the provenance verification service comprise a provenance verification status which indicates whether the first software product does or does not pass the provenance verification. In some embodiments, the results of the provenance verification service further comprise information corresponding to a specific software that generated the first software product for verification.

In some embodiments, the release channel is selected from a plurality of release channels, and at least two release channels of the plurality of release channels have different security policies. In some embodiments, the security policy requires the first software product to pass the provenance verification. In some embodiments, the security policy further requires that the first software product does not include a piece of software associated with a specific software license.

In some embodiments, the first software product is associated with a version. In some embodiments, the deployment management system is further configured to: in response to the first software product being determined to not satisfy the security policy, not allowing for the first software product to be installed through the release channel. In some embodiments, the one or more artifacts are retrieved based on one or more bytes of metadata associated with the first software product.

For example, some or all components of various embodiments of the present disclosure each are, individually and/or in combination with at least another component, implemented using one or more software components, one or more hardware components, and/or one or more combinations of software and hardware components. In another example, some or all components of various embodiments of the present disclosure each are, individually and/or in combination with at least another component, implemented in one or more circuits, such as one or more analog circuits and/or one or more digital circuits. In yet another example, while the embodiments described above refer to particular features, the scope of the present disclosure also includes embodiments having different combinations of features and embodiments that do not include all of the described features. In yet another example, various aspects of the present disclosure can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system (e.g., one or more components of the processing system) to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD, etc.) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation and can be implemented, for example, as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations, one or more features from a combination can in some cases be removed from the combination, and a combination may, for example, be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present disclosure have been described, it will be understood by those of skill in the art that there are other embodiments that are equivalent to the described embodiments. Accordingly, it is to be understood that the invention is not to be limited by the specific illustrated embodiments. Various modifications and alterations of the disclosed embodiments will be apparent to those skilled in the art. The embodiments described herein are illustrative examples. The features of one disclosed example can also be applied to all other disclosed examples unless otherwise indicated. It should also be understood that all U.S. patents, patent application publications, and other patent and non-patent documents referred to herein are incorporated by reference, to the extent they do not contradict the foregoing disclosure.

What is claimed is:

1. A method for verifying a software product using a software-supply-chain-provenance verification service, the method comprising:
receiving, at the software-supply-chain-provenance verification service from a deployment management system, an indication of a first software product for verification;
retrieving one or more artifacts associated with the first software product for verification;
performing provenance verification to the one or more artifacts to generate one or more results; and
sending the one or more results of the provenance verification and the indication of the first software product to the deployment management system,
wherein the deployment management system is configured to:
determine whether the first software product satisfies a security policy of a release channel based at least in part on the one or more results of the provenance verification; and
in response to the first software product being determined to satisfy the security policy, allow for the first software product to be installed through the release channel, and
wherein the method is performed using one or more processors.

2. The method of claim 1, wherein the one or more results of the provenance verification service comprise a provenance verification status which indicates whether the first software product does or does not pass the provenance verification.

3. The method of claim 2, wherein the one or more results of the provenance verification service further comprise information corresponding to a second software used in the first software product for verification.

4. The method of claim 1, wherein the release channel is selected from a plurality of release channels, and wherein at least two release channels of the plurality of release channels have different security policies.

5. The method of claim 1, wherein the security policy requires the first software product to pass the provenance verification.

6. The method of claim 5, wherein the security policy further requires that the first software product does not include a piece of software associated with a specific software license.

7. The method of claim 1, wherein the first software product is associated with a version.

8. The method of claim 1, wherein the deployment management system is further configured to: in response to the first software product being determined to not satisfy the security policy, not allowing for the first software product to be installed through the release channel.

9. The method of claim 1, wherein the one or more artifacts are retrieved based on one or more bytes of metadata associated with the first software product.

10. A method for verifying a software product using a software-supply-chain-provenance verification service, the method comprising:
sending, from a deployment management system to a software-supply-chain-provenance verification service, an indication of a first software product;
receiving, from the software-supply-chain-provenance verification service, one or more results of a provenance verification of one or more artifacts associated with the first software product;
storing the results of the provenance verification as a property of the indication of the first software product;
determining whether the first software product satisfies a security policy of a release channel based at least in part on the one or more results of the provenance verification; and
in response to the first software product being determined to satisfy the security policy, allowing for the first software product to be installed through the release channel,
wherein the method is performed using one or more processors.

11. The method of claim 10, wherein the one or more results of the provenance verification service comprise a provenance verification status which indicates whether the first software product does or does not pass the provenance verification.

12. The method of claim 11, wherein the one or more results of the provenance verification service further comprise information corresponding to a second software used in the first software product for verification.

13. The method of claim 10, wherein the release channel is selected from a plurality of release channels, and wherein at least two release channels of the plurality of release channels have different security policies.

14. The method of claim 10, wherein the security policy requires the first software product to pass the provenance verification.

15. The method of claim 14, wherein the security policy further requires that the first software product does not include a piece of software associated with a specific software license.

16. The method of claim 10, wherein the first software product is associated with a version.

17. The method of claim 10, further comprising: in response to the first software product being determined to not satisfy the security policy, not allowing for the first software product to be installed through the release channel.

18. The method of claim 10, wherein the one or more artifacts are retrieved based on one or more bytes of metadata associated with the first software product.

19. A system for verifying a software product using a software-supply-chain-provenance verification service, the system comprising:
a processor; and
memory storing instructions that, when executed by the processor, cause the system to perform a set of operations, the set of operations comprising:
sending, from a deployment management system to a software-supply-chain-provenance verification service, an indication of a first software product;
receiving, from the software-supply-chain-provenance verification service, one or more results of a provenance verification of one or more artifacts associated with the first software product;
storing the results of the provenance verification as a property of the indication of the first software product;
determining whether the first software product satisfies a security policy of a release channel based at least in part on the one or more results of the provenance verification; and
in response to the first software product being determined to satisfy the security policy, allowing for the first software product to be installed through the release channel.

20. The system of claim 19, wherein the one or more results of the provenance verification service comprise a provenance verification status which indicates whether the first software product does or does not pass the provenance verification.
